(19) United States
(12) Patent Application Publication
(10) Pub. No.: US 2019/0039022 A1
(43) Pub. Date: Feb. 7, 2019

(54) METHOD FOR CONTROLLING OPERATION OF REVERSE OSMOSIS MEMBRANE APPARATUS AND REVERSE OSMOSIS MEMBRANE TREATMENT SYSTEM

(71) Applicant: KURITA WATER INDUSTRIES LTD., Tokyo (JP)

(72) Inventors: Hidekuni KAMEDA, Tokyo (JP); Hideyuki KOMORI, Tokyo (JP)

(21) Appl. No.: 16/084,472

(22) PCT Filed: Sep. 20, 2016
(86) PCT No.: PCT/JP2016/077636

§ 371 Date: Sep. 12, 2018

(30) Foreign Application Priority Data
Mar. 18, 2016 (JP) 2016-055726

(51) Int. Cl. B01D 61/12; C02F 1/44

(52) U.S. Cl. CPC B01D 61/12; C02F 1/441; B01D 2311/10; B01D 2311/14; B01D 2311/22; B01D 2311/246; C02F 2303/22; C02F 2209/02; C02F 2209/03; C02F 2209/05; C02F 2209/40; C02F 2209/44; B01D 2321/40

(57) ABSTRACT

The formation of scale in a reverse osmosis membrane apparatus is reduced at low water temperatures without the necessity of pH adjustment or addition of a scale dispersant to continue a consistent operation for a long period of time. The operation of a reverse osmosis membrane apparatus is controlled on the basis of the concentration of aluminum ions and/or iron ions in the feed to the reverse osmosis membrane apparatus and/or the concentrate from the reverse osmosis membrane apparatus. Not only silica but also aluminum ions and iron ions that are also present in the water significantly affect the reduction in the flux of a reverse osmosis membrane which is caused by silica scale. It is necessary to appropriately control the concentration of aluminum ions and/or iron ions in the feed and/or the concentrate to consistently operate a reverse osmosis membrane apparatus for a long period of time.

### TECHNICAL FIELD

The present invention relates to a method for controlling operation of a reverse osmosis membrane apparatus which enables the reverse osmosis membrane apparatus to consistently operate over a long period of time even at a low water temperature (e.g., water temperature of 5° C. to 10° C.), and a reverse osmosis membrane treatment system capable of consistently operating over a long period of time even at the low water temperature.

The term “reverse osmosis membrane” used herein is used in a broad sense and refers to a reverse osmosis membrane and a nanofiltration membrane.

### BACKGROUND ART

Reverse osmosis membranes, which are composed of a dense surface layer and a porous support layer and allow solvent molecules to permeate therethrough but reject solute molecules, have enabled single-stage desalination of seawater. Reverse osmosis membranes have been becoming popular in various industries. Low-pressure reverse osmosis membranes capable of operating at a low pressure have been developed. Consequently, reverse osmosis membranes have come into use for cleaning water generated in the secondary treatment of sewage, industrial wastewater, river water, lake water, landfill leachate, and the like.

Since reverse osmosis membranes are capable of rejecting a solute at a high rejection rate, permeate produced by the reverse osmosis membrane treatment has good qualities. Therefore, reverse osmosis membranes can be used in various applications effectively. Since a flow rate of water treated by a reverse osmosis membrane apparatus gradually decreases as the operation of the reverse osmosis membrane apparatus continues, it is important to appropriately control the qualities of the feed to the reverse osmosis membrane apparatus and the method for operating the reverse osmosis membrane apparatus. In particular, in the case where the temperature of the water is low, scale composed primarily of silica is highly likely to be generated and the silica scale deposited on the membrane surface may reduce the flux through the membrane.

In the case where tap water is used as raw water, the concentration of silica in the feed is about 10 to 20 mg/L. On the other hand, the solubility of silica in water at a low temperature is low. In particular, the solubility of silica in water at 5° C. is 20 mg/L (at equilibrium). This makes it difficult to concentrate the feed through a reverse osmosis membrane.

Although a reverse osmosis membrane apparatus is operated such that the silica concentration is kept below the saturation solubility of silica, silica scale may be formed on the surface of the membrane and reduce the flux through the membrane.

A common approach to addressing the above issue is to adjust the pH of the feed or to use a scale dispersant. For example, a scale dispersant is added to feed water, and the pH of the feed is adjusted to be about 5.5 (PTL 1).

In another method, a scale dispersant is added to the feed water and the apparatus is operated such that the Langelier index of the concentrate is 0.3 or less and the silica concentration in the concentrate is 150 mg/L or less (PTLs 2 to 4).

However, adding an excessive amount of acid to the feed water for pH adjustment causes to form dissolved carbon dioxide from hydrogencarbonate ions and carbonate ions present in the feed. The carbon dioxide permeate through a reverse osmosis membrane and may degrade the qualities of the treated water.

The method in which a scale dispersant is used involves a risk of scale being formed when the addition of the chemical is failed. In addition, the costs of the chemical may be an economic burden.

PTL 1: JP H9-206749 A

PTL 2: JP 5287908 B

PTL 3: JP 5757109 B

PTL 4: JP 5757110 B

Since scale formed on the surface of a reverse osmosis membrane significantly reduces the amount of treated water, it is necessary to set the concentrations in the feed and the operation method appropriately for achieving a consistent operation over a long period of time.

### SUMMARY OF INVENTION

An object of the present invention is to provide a method for controlling operation of a reverse osmosis membrane apparatus and a reverse osmosis membrane treatment system that formation of silica scale in a reverse osmosis membrane apparatus is reduced even at a low water temperature of 5° C. to 10° C. without the necessity of pH adjustment or addition of a scale dispersant in order to continue a consistent operation over a long period of time.

The inventor of the present invention researched mechanisms by which silica scale reduces the flux through a reverse osmosis membrane and, as a result, found that not only silica but also ions that are also present in the water, that is, in particular, aluminum ions and iron ions, significantly affect the reduction in the flux through a reverse osmosis membrane caused by silica scale. The inventor of the present invention also found that it is important for consistently operating a reverse osmosis membrane apparatus over a long period of time to appropriately control the silica concentration in the feed and/or the concentrate and the concentration of aluminum ions and/or iron ions in the feed and/or the concentrate.

The summary of the present invention is as follows.

[1] A method for controlling operation of a reverse osmosis membrane apparatus, in which raw water is treated through the reverse osmosis membrane apparatus,

wherein the reverse osmosis membrane apparatus is controlled on the basis of concentration of aluminum ions and/or iron ions in water fed to the reverse osmosis membrane apparatus (hereinafter, this water is referred to as “feed”) and/or concentrate from the reverse osmosis membrane apparatus.

[2] The method for controlling operation of a reverse osmosis membrane apparatus according to [1], wherein one or more items selected from 1) to 9) below are controlled on the basis of the concentration of aluminum ions and/or iron ions in the feed and/or the concentrate.

1) Suitability of raw water as the feed

2) Temperature of the feed

3) Concentration rate or recovery rate of the reverse osmosis membrane apparatus

4) Pressure at which the feed is fed to the reverse osmosis membrane apparatus, pressure of the concentrate, or pressure of treated water from the reverse osmosis membrane apparatus

5) Flow rate of the concentrate

6) Length of time during which the reverse osmosis membrane apparatus is continuously operated

7) Length of time during which the reverse osmosis membrane apparatus is cleaned

8) Frequency at which the reverse osmosis membrane apparatus is cleaned

9) Timing at which a reverse osmosis membrane of the reverse osmosis membrane apparatus is replaced

[3] The method for controlling operation of a reverse osmosis membrane apparatus according to [1] or [2], wherein the operation of the reverse osmosis membrane apparatus is controlled on the basis of the total concentration of aluminum ions and iron ions in the feed and/or the concentrate.

[4] The method for controlling operation of a reverse osmosis membrane apparatus according to any one of [1] to [3], wherein the concentration of aluminum ions and/or iron ions is set on the basis of one or more indices selected from the length of time during which the reverse osmosis membrane apparatus is continuously operated, the length of time during which the reverse osmosis membrane apparatus is cleaned, the concentration rate, and a quality of the feed.

[5] The method for controlling operation of a reverse osmosis membrane apparatus according to any one of [1] to [4], wherein the operation of the reverse osmosis membrane apparatus is controlled such that the concentration of aluminum ions in the concentrate is 0.4 mg/L or less and the concentration of iron ions in the concentrate is 0.8 mg/L or less, or such that the total concentration of aluminum ions and iron ions in the concentrate is 1.0 mg/L or less.

[6] The method for controlling operation of a reverse osmosis membrane apparatus according to any one of [1] to [5], wherein the operation of the reverse osmosis membrane apparatus is controlled on the basis of the concentration of aluminum ions and/or iron ions in the feed and/or the concentrate and concentration of silica in the feed and/or the concentrate.

[7] The method for controlling operation of a reverse osmosis membrane apparatus according to [6], wherein the operation of the reverse osmosis membrane apparatus is controlled such that the concentration of silica in the concentrate is 80 mg/L or less.

[8] The method for controlling operation of a reverse osmosis membrane apparatus according to any one of [1] to [6], wherein the temperature of the feed is 5° C. to 10° C. at a first period and exceeds 10° C. at a second period; and,

wherein during the first period of the temperature being 5° C. to 10° C., the operation of the reverse osmosis membrane apparatus is controlled according to said method for controlling operation of a reverse osmosis membrane apparatus and according to an operation method based on silica concentration and/or Langelier index.

[9] A reverse osmosis membrane treatment system comprising:

a reverse osmosis membrane apparatus that treats raw water through a reverse osmosis membrane; and,

a measurement unit that measures concentration of aluminum ions and/or iron ions in water fed to the reverse osmosis membrane apparatus (hereinafter, this water is referred to as “feed”) and/or concentrate from the reverse osmosis membrane apparatus.

[10] The reverse osmosis membrane treatment system according to [9], further comprising a control unit that controls one or more items selected from 1) to 9) below on the basis of the concentration of aluminum ions and/or iron ions measured by the measurement unit.

1) Suitability of raw water as the feed

2) Temperature of the feed

3) Concentration rate or recovery rate of the reverse osmosis membrane apparatus

4) Pressure at which the feed is fed to the reverse osmosis membrane apparatus, pressure of the concentrate, or pressure of treated water from the reverse osmosis membrane apparatus

5) Flow rate of the concentrate

6) Length of time during which the reverse osmosis membrane apparatus is continuously operated

7) Length of time during which the reverse osmosis membrane apparatus is cleaned

8) Frequency at which the reverse osmosis membrane apparatus is cleaned

9) Timing at which a reverse osmosis membrane of the reverse osmosis membrane apparatus is replaced

[11] The reverse osmosis membrane treatment system according to [10], wherein the control unit controls the items on the basis of the total concentration of aluminum ions and iron ions in the feed and/or the concentrate measured by the measurement unit.

[12] The reverse osmosis membrane treatment system according to [10] or [11], wherein the control unit controls the items such that the concentration of aluminum ions in the concentrate is 0.4 mg/L or less and the concentration of iron ions in the concentrate is 0.8 mg/L or less, or such that the total concentration of aluminum ions and iron ions in the concentrate is 1.0 mg/L or less.

[13] The reverse osmosis membrane treatment system according to any one of [10] to [12], further comprising a unit that measures the concentration of silica in the feed and/or the concentrate, wherein the control unit controls the items on the basis of the concentration of aluminum ions and/or iron ions and the concentration of silica.

[14] The reverse osmosis membrane treatment system according to [13], wherein the control unit controls the items such that the concentration of silica in the concentrate is 80 mg/L or less.

### Advantageous Effects of Invention

According to the present invention, it is possible to consistently operate a reverse osmosis membrane apparatus with a high flux over a long period of time without the necessity of pH adjustment or addition of a scale dispersant by controlling the operation of the reverse osmosis membrane apparatus on the basis of water qualities. The formation of scale can be reduced and the consistent high-flux operation can be achieved even in the case where the temperature of the feed is low (e.g., 5° C. to 10° C.)

For example, it is possible to continuously operate a reverse osmosis membrane apparatus for at least 3 months or more without cleaning, during which the normalized flux does not fall below 70% of the initial flux.

While the method in which a scale dispersant is used as in the conventional methods involves a risk of scale being formed when the addition of the chemical is failed, the present invention does not have such a disadvantage since the present invention addresses the above issues without using a scale dispersant.

### BRIEF DESCRIPTION OF DRAWINGS

FIG. 1 is a schematic flow diagram illustrating a reverse osmosis membrane treatment system according to an embodiment of the present invention.

### DESCRIPTION OF EMBODIMENTS

An embodiment of the present invention is described below in detail.

<Feed>

Examples of the raw water to be treated through a reverse osmosis membrane in the present invention include, but are not limited to, tap water, clarified industrial water, and well water.

In order to achieve the continuous operation over a long period of time, there has been used a method in which the qualities of the feed to a reverse osmosis membrane are assessed in terms of the fouling index (FI) defined by JIS K3802, the silt density index (SDI) defined by ASTM D4189, or the MF index devised by Taniguchi as a simpler evaluation method (Desalination, vol. 20, p. 353-364, 1977) and the feed is clarified such that the index is reduced to be a predetermined value or less. Specifically, the raw water is pre-treated as needed such that the FI or SDI of the feed is reduced to, for example, 3 to 4 or less in order to clarify the feed to a certain degree. It is also preferable in the present invention to reduce the FI of the feed to 4 or less by performing a pre-treatment, such as clarification, as needed.

<Structure of Reverse Osmosis Membrane Treatment System>

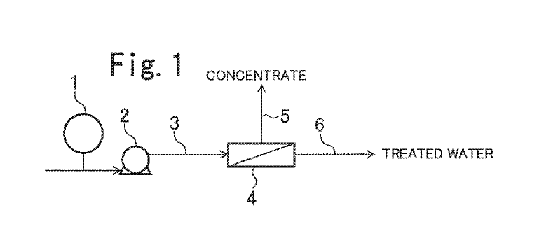

FIG. 1 is a schematic flow diagram illustrating an example of a reverse osmosis membrane treatment system according to the embodiment of the present invention. The raw water fed from a raw water tank (not illustrated) is passed into a reverse osmosis membrane apparatus 4 through a feed pipe 3 with a feed pump that is not illustrated and a high-pressure pump 2 provided for the reverse osmosis membrane apparatus. The water permeate through the reverse osmosis membrane, that is, the permeate, is discharged through a treated-water pipe 6. The concentrate is discharged through a concentrate pipe 5.

The feed pipe 3 is provided with a control gage 1 disposed thereon, which measures the concentration of aluminum ions and/or iron ions in the feed. The operation of the reverse osmosis membrane apparatus is controlled on the basis of the measurement results.

The control gage 1 may be disposed on the concentrate pipe 5 or may be disposed on both concentrate pipe 5 and feed pipe 3. The feed pipe 3 and/or the concentrate pipe 5 may be further provided with another control gage that measures the silica concentration and the Langelier index of the water, which are also used for controlling the operation. Alternatively, the control gage 1 may serve also as a gage that measures and controls the silica concentration and/or the Langelier index.

The basic conditions under which the reverse osmosis membrane apparatus is operated are not limited. In the case where the flow rate of concentrate of 3.6 m³/hr or more is to be maintained and the reverse osmosis membrane is an ultra-low-pressure reverse osmosis membrane, the standard pressure is 0.735 MPa, the membrane area is 35 to 41 m², the initial pure-water flux is 1.0 m/day (25° C.) or more, and the initial salt rejection rate is 98% or more. Since the rates at which a reverse osmosis membrane rejects aluminum ions and iron ions does not vary significantly with the type of the reverse osmosis membrane, the type of the membrane may be selected independently of the rejection rate of the membrane.

<Control of Operation of Reverse Osmosis Membrane Apparatus>

In the present invention, the concentration of aluminum ions and/or iron ions in the feed and/or the concentrate is measured, and the operation of the reverse osmosis membrane apparatus is controlled on the basis of the concentration of aluminum ions and/or iron ions (hereinafter, may be referred to as “the Al/Fe concentration”).

The operation is controlled in terms of one or more items selected from 1) to 9) below.

1) Suitability of raw water as the feed

2) Temperature of the feed

3) Concentration rate or recovery rate of the reverse osmosis membrane apparatus

4) Pressure at which the feed is fed to the reverse osmosis membrane apparatus, pressure of the concentrate, or pressure of treated water from the reverse osmosis membrane apparatus

5) Flow rate of the concentrate

6) Length of time during which the reverse osmosis membrane apparatus is continuously operated

7) Length of time during which the reverse osmosis membrane apparatus is cleaned

8) Frequency at which the reverse osmosis membrane apparatus is cleaned

9) Timing at which a reverse osmosis membrane of the reverse osmosis membrane apparatus is replaced

A specific example of the method for controlling the operation is as follows.

(1) When the Al/Fe concentration is equal to or lower than a predetermined concentration, the raw water is fed to the reverse osmosis membrane apparatus without treatment. When the Al/Fe concentration is higher than the predetermined concentration, the raw water is assessed as inappropriate as feed and the feeding of the raw water to the reverse osmosis membrane is stopped. Alternatively, in order to reduce the Al/Fe concentration to be the predetermined concentration or less, the concentration of aluminum ions and/or iron ions in the raw water may be reduced by performing an iron removal/manganese removal treatment, an ion-exchange treatment, or the like before the raw water is fed to the reverse osmosis membrane apparatus. In the case where a coagulation treatment is performed using PAC, iron chloride, or the like at a position upstream of the reverse osmosis membrane apparatus, it is preferable to change the coagulation conditions adequately because the coagulation treatment may affect the cycle of cleaning.

(2) When the Al/Fe concentration is equal to or lower than a predetermined concentration, the operation of the reverse osmosis membrane apparatus is continued under the same conditions as before. When the Al/Fe concentration is higher than the predetermined concentration, the temperature of the feed is increased.

(3) When the Al/Fe concentration is higher than a predetermined concentration, the flux through the membrane, the pressure of the feed, or the concentration rate (i.e., the recovery rate) of the apparatus is reduced. When the Al/Fe concentration is lower than the predetermined concentration, the flux through the membrane, the pressure of the feed, or the concentration rate (i.e., the recovery rate) of the apparatus is increased.

(4) When the Al/Fe concentration is higher than a predetermined concentration, the length of continuous operation time is reduced, the cleaning time or the cleaning frequency is increased, or the intervals at which the reverse osmosis membrane is replaced is reduced (i.e., the frequency of replacing the reverse osmosis membrane is reduced). When the Al/Fe concentration is lower than the predetermined concentration, conversely, the length of continuous operation time is increased, the cleaning time or the cleaning frequency is reduced, or the intervals at which the reverse osmosis membrane is replaced is increased (i.e., the frequency of replacing the reverse osmosis membrane is increased).

The predetermined Al/Fe concentration is set on the basis of the specifications of the reverse osmosis membrane apparatus, the other operation conditions, etc. adequately such that the desired consistent operation can be achieved. For example, regardless of whether the temperature of the feed is low (e.g., 5° C. to 10° C.) or 10° C. or more, the predetermined Al/Fe concentration in the concentrate is set adequately so as to fall within the following ranges: aluminum ion concentration: 0.01 to 0.4 mg/L; iron ion concentration: 0.01 to 0.8 mg/L; and total concentration of aluminum ions and iron ions: 0.02 to 1.0 mg/L.

In the present invention, any of the length of continuous operation time of the concentrate, the length of cleaning time, the concentration rate, and the water temperature may be set on the basis of the Al/Fe concentration. Alternatively, the above items may be controlled such that the Al/Fe concentration of the concentrate is the predetermined concentration or less.

For example, it is possible to continuously operate the reverse osmosis membrane apparatus for a long period of time without maintenance or cleaning even when the feed has a low temperature of 5° C. to 10° C. by controlling the operation of the apparatus such that the concentration of aluminum ions in the concentrate is 0.4 mg/L or less, the concentration of iron ions in the concentrate is 0.8 mg/L or less, and the total concentration of aluminum ions and iron ions in the concentrate is 1 mg/L or less.

For example, as described in Table 3 below, it is possible to continuously operate the reverse osmosis membrane apparatus for 3 months or more without maintenance by controlling the concentration of aluminum ions in the concentrate to be 0.2 mg/L or less, the concentration of iron ions in the concentrate to be 0.2 mg/L or less, and the total concentration of aluminum ions and iron ions in the concentrate to be 0.2 mg/L or less.

In addition to the Al/Fe concentration, the silica concentration in the feed and/or the concentrate may be used as a control index. In such a case, it is preferable to control the operation such that the silica concentration in the concentrate is 80 mg/L or less. It is particularly preferable to control the silica concentration in the concentrate to be 60 mg/L or less.

The operation of the reverse osmosis membrane apparatus can be controlled on the basis of the Al/Fe concentration regardless of the temperature of the feed. In the case where the temperature of the feed is lower than 10° C., it is preferable to control the operation of the apparatus also on the basis of other control indices, such as the silica concentration in the concentrate and/or the Langelier index of the concentrate.

A specific operation control method is described below.

When the temperature of the feed is 5° C. to 10° C., the recovery rate is determined on the basis of the silica concentration and the calcium hardness in the feed or the concentrate or the concentrations of aluminum ions and iron ions in the concentrate, and the lowest of the recovery rates determined on the basis of the respective indices is used as a recovery rate.

In such a case, first, the recovery rate at which the silica concentration in the concentrate is 80 mg/L or less and is preferably 60 mg/L or less is determined. For example, in the case where the silica concentration in the feed is 20 mg/L, the recovery rate is about 70%.

The recovery rate is also determined such that the Langelier index of the concentrate is 0 or less.

The recovery rate is also determined such that the concentration of aluminum ions in the concentrate is 0.4 mg/L or less and the concentration of iron ions in the concentrate is 0.8 or less, or such that the total of the above concentrations is 1 mg/L or less.

Operating the reverse osmosis membrane apparatus at the lowest of the three recovery rates enables a consistent operation to be achieved over a long period of time while limiting the reduction in flux.

<Flushing>

In the present invention, it is preferable to perform low-pressure flushing as described below while the operation of the reverse osmosis membrane apparatus is stopped.

The equilibrium concentration of silica in water at 5° C. is 20 mg/L. Since the polymerization rate of silica is low, the acceptable limit for the silica concentration in the concentrate is 80 mg/L. However, if the operation of the apparatus is stopped under such a condition, silica may precipitate on the concentrate side of the apparatus. Accordingly, low-pressure flushing is performed.

Low-pressure flushing is performed by passing a certain amount of flush water at a certain pressure as described below by stopping the high-pressure pump provided for the reverse osmosis membrane apparatus and using only the feed pump and keeping the apparatus in this state for a predetermined amount of time.

Pressure: about 0.1 to 0.3 MPa

Amount of water: 3 times or more (e.g., about 3 to 5 times) the amount of water contained in the reverse osmosis membrane vessel

It is preferable to again perform the low-pressure flushing described above when the operation of the apparatus is stopped for 5 hours or more since the low-pressure flushing was last performed during the suspension of the operation.

<Other Treatments>

An electrodeionization apparatus or an ion-exchange apparatus may be disposed downstream of the reverse osmosis membrane apparatus according to the present invention in order to further treat the permeate produced through the reverse osmosis membrane. A safety filter may be disposed upstream of the reverse osmosis membrane apparatus. In the case where the concentration of residual chlorine in the raw water is high, a unit for removing residual chlorine, such as an active carbon column, may be disposed upstream of the reverse osmosis membrane apparatus.

### EXAMPLES

The present invention is described below more specifically with reference to Test examples instead of Examples.

### Test Example 1

A reverse osmosis membrane apparatus was operated under the following conditions.

<<Test Conditions>>

Raw water: Nogi-machi tap water

Flow rate of permeate through the membrane: 0.6 to 0.8 m/day

Reverse osmosis membrane: Ultra-low-pressure reverse osmosis membrane “ES-20” produced by Nitto Denko Corporation

Recovery rate: 75%

Feed temperature (entrance of reverse osmosis membrane): 5° C. to 8° C.

Silica concentration in feed: about 16 mg/L

Run 1 was conducted using Nogi-machi tap water without adding any chemical. In Run 2, magnesium chloride, ferric chloride, and aluminum chloride as Mg, Fe, and Al sources respectively were added to Nogi-machi tap water at predetermined concentrations.

The concentration of the above constituents in the feed to the reverse osmosis membrane apparatus and the concentrate from the reverse osmosis membrane apparatus in Runs 1 and 2 were measured in order to determine the concentration rate for each of the constituents and the concentration rate of water. The rate of pressure difference rise was determined from the pressure difference that occurred while the apparatus was operated for four days. Table 1 shows the results.

TABLE 1

| | | | | | | | | | | | | | Flow rate | |
|---|---|---|---|---|---|---|---|---|---|---|---|---|---|---|
| | SiO₂ | | Ca | | Mg | | Fe | | Al | | Cl | TOC | of water | Rate of |
| | | Concen- | | Concen- | | Concen- | | Concen- | | Concen- | Concen- | Concen- | Concen- | pressure |
| | Concen- | tration | Concen- | tration | Concen- | tration | Concen- | tration | Concen- | tration | tration | tration | tration | difference |
| | tration | rate | tration | rate | tration | rate | tration | rate | tration | rate | rate | rate | rate | rise |
| Sample | (mg/L) | (times) | (mg/L) | (times) | (mg/L) | (times) | (mg/L) | (times) | (mg/L) | (times) | (times) | (times) | (times) | (MPa/day) |
| Feed | 16.2 | 4.2 | 14.6 | 4.5 | 3.9 | 4.1 | 0.0004 | 5.2 | 0.0149 | 4.7 | 4.1 | 4.1 | 4.3 | 0 |
| Concen- | 68.0 | | 65.6 | | 15.8 | | 0.0021 | | 0.0693 | | | | | |
| trate | | | | | | | | | | | | | | |
| Feed | 16.7 | 4.3 | 13.6 | 4.7 | 8.4 | 4.1 | 0.0065 | 0.7 | 0.0307 | 4.3 | 4.2 | — | 4.2 | 0.013 |
| Concen- | 71.6 | | 64.0 | | 34.8 | | 0.0043 | | 0.1322 | | | | | |
| trate | | | | | | | | | | | | | | |

As is clear from the results shown in Table 1, an increase in pressure difference is observed in Run 2. Since the material balance of Fe was not achieved in Run 2, it is considered that the surface of the reverse osmosis membrane was clogged with the Fe component. It is also considered that Al was adhered on the surface of the membrane, because the error in the material balance of Al was relatively large compared with the other ions present in the water.

Table 2 shows the results of the analysis of the elements adhered on the surface of the reverse osmosis membrane used in the operation of Run 2. The results of Table 2 confirm that, among the ions present in the water, Al and Fe were adhered on the surface of the membrane in particularly large amounts.

TABLE 2

| | | Number of |
|---|---|---|
| | Mass | atoms |
| Element | (%) | (%) |
| Mg | 0.21 | 0.15 |
| Al | 2.27 | 1.45 |
| Si | 4.86 | 2.98 |
| Ca | 0.9 | 0.39 |
| Fe | 3.08 | 0.95 |
| Others | 88.68 | 94.08 |
| Total | 100 | 100 |

### Test Example 2

Tap water having a temperature of 5° C. and a silica concentration of 20 mg/L from which residual chlorine had been removed was used as feed to the reverse osmosis membrane apparatus. Aluminum chloride and ferric chloride as Al and Fe sources respectively were added to the feed in order to adjust the Al and Fe concentration in the feed to be predetermined concentrations. The feed was subsequently concentrated three times through an ultra-low-pressure reverse osmosis membrane “ES-20” produced by Nitto Denko Corporation (silica concentration in the concentrate: 60 mg/L).

The relationships between the concentration of Al and Fe and the total concentration of Fe and Al in the concentrate from the reverse osmosis membrane treatment, which were determined by calculation, and the amount of operation time it took for the normalized flux to fall below 70% of the initial flux (hereinafter, may be referred to as “the number of 70%-operation continuable days”), which was determined from the rate of flux decline, were determined by changing the concentrations of Al and Fe in the feed and graphed. Table 3 summarizes the results. In Table 3, the number of 70%-operation continuable days is expressed in months.

TABLE 3

| | | Examples | | | | | | | Comparative examples | | |
|---|---|---|---|---|---|---|---|---|---|---|---|
| | | Condi- | Condi- | Condi- | Condi- | Condi- | Condi- | Condi- | Condi- | Condi- | Condi- |
| Item | Unit | tion 1 | tion 2 | tion 3 | tion 4 | tion 5 | tion 6 | tion 7 | tion 1 | tion 2 | tion 3 |
| Al concentration in | mg/L | 0.02 | 0.04 | 0.03 | 0.1 | 0.04 | 0.16 | 0.3 | 0.6 | 0.1 | 0.4 |
| concentrate, calculated | | | | | | | | | | | |
| Fe concentration in | mg/L | 0.04 | 0.02 | 0.1 | 0.03 | 0.16 | 0.04 | 0.7 | 0.4 | 0.9 | 0.8 |
| concentrate, calculated | | | | | | | | | | | |
| Al + Fe concentration in | mg/L | 0.06 | 0.06 | 0.13 | 0.13 | 0.2 | 0.2 | 1 | 1 | 1 | 1.2 |
| concentrate, calculated | | | | | | | | | | | |
| Number of 70%-operation | Months | 12 | 11 | 6 | 5.5 | 3 | 2.7 | 0.5 | 0.2 | 0.4 | 0.1 |
| continuable days | | | | | | | | | | | |

Calculated concentration in concentrate = [concentration in feed] · [concentration rate based on amount of water]

The results shown in Table 3 show that the number of 70%-operation continuable days varies with the concentrations of Al and Fe in the concentrate and the total concentrations of Al and Fe in the concentrate.

The results obtained under Conditions 1 and 2, Conditions 3 and 4, and Conditions 6 and 7 in Examples show that the Al concentration has a larger impact on the number of operation continuable days than the Fe concentration.

It is clear from the results obtained under Condition 7 in Examples and the results obtained under Conditions 1 to 3 in Comparative examples that it is possible to consistently operate the reverse osmosis membrane over a long period of time by setting the Al concentration (calculated) in the concentrate to 0.4 mg/L or less, the Fe concentration (calculated) in the concentrate to 0.8 mg/L or less, and the total concentration of Al and Fe in the concentrate (calculated) to 1.0 mg/L or less.

Table 3 shows the number of 70%-operation continuable days calculated from some of the graphed data. The above results may be used for controlling the operation of the apparatus in the following manner.

For example, the relation between the number of operation continuable days and the Al/Fe concentration is determined from the slope of the graph. A predetermined number of days, which is the number of operation continuable days, is substituted into the relation in order to calculate an Al/Fe concentration. Items such as the concentration rate (i.e., the recovery rate) are controlled such that the Al/Fe concentration in the concentrate is equal to the calculated Al/Fe concentration.

Alternatively, the Al/Fe concentration may be substituted into the relation in order to calculate the number of 70%-operation continuable days and the amount of times during which the apparatus can be operated continuously may be set accordingly. That is, the cycle of cleaning may be estimated. In another case, the maximum limit for the concentration rate may be calculated from the Al/Fe concentration in the feed.

In Table 3, length of operation time required for the normalized flux to fall below 70% of the initial flux was evaluated. The reduction from the initial flux is not limited to 70% and may be set adequately such that the apparatus can be operated under the desired conditions, such as cleaning frequency.

Although the present invention has been described in detail with reference to particular embodiments, it is apparent to a person skilled in the art that various modifications can be made therein without departing from the spirit and scope of the present invention.

The present application is based on Japanese Patent Application No. 2016-055726 filed on Mar. 18, 2016, which is incorporated herein by reference in its entirety.

### REFERENCE SIGNS LIST

1 CONTROL GAGE
2 HIGH-PRESSURE PUMP
3 FEED PIPE
4 REVERSE OSMOSIS MEMBRANE APPARATUS
5 CONCENTRATE PIPE
6 TREATED-WATER PIPE

1. A method for controlling operation of a reverse osmosis membrane apparatus, in which raw water is treated through the reverse osmosis membrane apparatus,
wherein the reverse osmosis membrane apparatus is controlled on the basis of concentration of aluminum ions and/or iron ions in water fed to the reverse osmosis membrane apparatus (hereinafter, this water is referred to as “feed”) and/or concentrate from the reverse osmosis membrane apparatus.

2. The method for controlling operation of a reverse osmosis membrane apparatus according to claim 1, wherein one or more items selected from 1) to 9) below are controlled on the basis of the concentration of aluminum ions and/or iron ions in the feed and/or the concentrate.
1) Suitability of raw water as the feed
2) Temperature of the feed
3) Concentration rate or recovery rate of the reverse osmosis membrane apparatus
4) Pressure at which the feed is fed to the reverse osmosis membrane apparatus, pressure of the concentrate, or pressure of treated water from the reverse osmosis membrane apparatus
5) Flow rate of the concentrate
6) Length of time during which the reverse osmosis membrane apparatus is continuously operated
7) Length of time during which the reverse osmosis membrane apparatus is cleaned
8) Frequency at which the reverse osmosis membrane apparatus is cleaned
9) Timing at which a reverse osmosis membrane of the reverse osmosis membrane apparatus is replaced

3. The method for controlling operation of a reverse osmosis membrane apparatus according to claim 1, wherein the operation of the reverse osmosis membrane apparatus is controlled on the basis of the total concentration of aluminum ions and iron ions in the feed and/or the concentrate.

4. The method for controlling operation of a reverse osmosis membrane apparatus according to claim 1, wherein the concentration of aluminum ions and/or iron ions is set on the basis of one or more indices selected from the length of time during which the reverse osmosis membrane apparatus is continuously operated, the length of time during which the reverse osmosis membrane apparatus is cleaned, the concentration rate, and a quality of the feed.

5. The method for controlling operation of a reverse osmosis membrane apparatus according to claim 1, wherein the operation of the reverse osmosis membrane apparatus is controlled such that the concentration of aluminum ions in the concentrate is 0.4 mg/L or less and the concentration of iron ions in the concentrate is 0.8 mg/L or less, or such that the total concentration of aluminum ions and iron ions in the concentrate is 1.0 mg/L or less.

6. The method for controlling operation of a reverse osmosis membrane apparatus according to claim 1, wherein the operation of the reverse osmosis membrane apparatus is controlled on the basis of the concentration of aluminum ions and/or iron ions in the feed and/or the concentrate and concentration of silica in the feed and/or the concentrate.

7. The method for controlling operation of a reverse osmosis membrane apparatus according to claim 6, wherein the operation of the reverse osmosis membrane apparatus is controlled such that the concentration of silica in the concentrate is 80 mg/L or less.

8. The method for controlling operation of a reverse osmosis membrane apparatus according to claim 1, wherein the temperature of the feed is 5° C. to 10° C. at a first period and exceeds 10° C. at a second period; and,
wherein during the first period of the temperature being 5° C. to 10° C., the operation of the reverse osmosis membrane apparatus is controlled according to said method for controlling operation of a reverse osmosis membrane apparatus and according to an operation method based on silica concentration and/or Langelier index.

9. A reverse osmosis membrane treatment system comprising: a reverse osmosis membrane apparatus that treats raw water through a reverse osmosis membrane; and,
a measurement unit that measures concentration of aluminum ions and/or iron ions in water fed to the reverse osmosis membrane apparatus (hereinafter, this water is referred to as “feed”) and/or concentrate from the reverse osmosis membrane apparatus.

10. The reverse osmosis membrane treatment system according to claim 9, further comprising a control unit that controls one or more items selected from 1) to 9) below on the basis of the concentration of aluminum ions and/or iron ions measured by the measurement unit.
1) Suitability of raw water as the feed
2) Temperature of the feed
3) Concentration rate or recovery rate of the reverse osmosis membrane apparatus
4) Pressure at which the feed is fed to the reverse osmosis membrane apparatus, pressure of the concentrate, or pressure of treated water from the reverse osmosis membrane apparatus
5) Flow rate of the concentrate
6) Length of time during which the reverse osmosis membrane apparatus is continuously operated
7) Length of time during which the reverse osmosis membrane apparatus is cleaned
8) Frequency at which the reverse osmosis membrane apparatus is cleaned
9) Timing at which a reverse osmosis membrane of the reverse osmosis membrane apparatus is replaced

11. The reverse osmosis membrane treatment system according to claim 10, wherein the control unit controls the items on the basis of the total concentration of aluminum ions and iron ions in the feed and/or the concentrate measured by the measurement unit.

12. The reverse osmosis membrane treatment system according to claim 10, wherein the control unit controls the items such that the concentration of aluminum ions in the concentrate is 0.4 mg/L or less and the concentration of iron ions in the concentrate is 0.8 mg/L or less, or such that the total concentration of aluminum ions and iron ions in the concentrate is 1.0 mg/L or less.

13. The reverse osmosis membrane treatment system according to claim 10, further comprising a unit that measures the concentration of silica in the feed and/or the concentrate, wherein the control unit controls the items on the basis of the concentration of aluminum ions and/or iron ions and the concentration of silica.

14. The reverse osmosis membrane treatment system according to claim 13, wherein the control unit controls the items such that the concentration of silica in the concentrate is 80 mg/L or less.
